(19) United States
(12) Patent Application Publication
(10) Pub. No.: US 2019/0114595 A1
(43) Pub. Date: Apr. 18, 2019

(54) Systems and Methods for Joint Control of Multi-Modal Transportation Networks

(71) Applicant: Mitsubishi Electric Research Laboratories, Inc., Cambridge, MA (US)

(72) Inventors: Arvind Raghunathan, Medford, MA (US); David Bergman, Waltham, MA (US); Thiago Serra Azevedo Silva, Pittsburgh, PA (US)

(21) Appl. No.: 15/785,540

(22) Filed: Oct. 17, 2017

(51) Int. Cl. G06Q 10/10

(52) U.S. Cl. CPC G06Q 10/1093

(57) ABSTRACT

Systems and Methods for controlling vehicles in a multi-modal transportation network having fixed schedule vehicles and commuter vehicles, including a receiver to receive a request for transportation from passengers in a set of passengers. Jointly optimize travel times of the passengers to reach their corresponding target locations. The joint optimization is based on identifying groups of passengers from the set of passengers to obtain a set of groups of passengers. Assign an identified group to a commuter vehicle leaving or reaching an intermediate location, according to a schedule from a set of schedules associated with the identified group, by optimizing jointly a function of a total travel time of the set of passengers, according to at least one schedule of the set of schedules associated with each group, to obtain an assigned travel itinerary for each passenger. Transmit to each passenger their assigned travel itinerary in the network.

### FIELD

The present disclosure relates generally to multi-modal transportation network, and more particularly to jointly controlling schedules of transport forming at least part of the multi-modal transportation network.

### BACKGROUND

Obtaining a multi-modal route through a multi-modal transportation network presents certain challenges. Such transportation networks typically include sub-networks of different types, i.e. associated with different modes of transport. These differences in the properties of the different types of network make it difficult to generate a multi-modal route across both types of network, as a conventional routing and/or scheduling methods tend to be specific to a certain type of transportation network. Current attempts to obtain a multi-modal route involve exploring the different networks separately to determine routes there through. For example, a route may be determined from a departure point through a network associated with one mode of transport to a departure point for another mode of transport, and then a route from the departure point for the other mode of transport to the destination determined through a network associated with the other mode of transport.

By way of example, a multi-modal transportation network may include a public transportation sub-network, and a private transportation sub-network for use by private transport, e.g. a road network (a “private transportation sub-network” as referred to herein). These types of network have different properties. Times of entry, exit and travel through a public transportation network are constrained, such that entry, exit and travel through the network may only occur at specific times, i.e. in accordance with a schedule associated with the network. In contrast, such constraints do not exist in relation to a private transportation network, such as a road network, when using private transport. In a private transportation network, a user may choose to enter, exit or travel through the network freely, at a time of their choosing.

Examples of public transportation include various fixed schedule vehicles, i.e., vehicles with fixed and/or predetermined schedule and cannot be modified to suit the convenience or requirements of the user. Examples of the fixed schedule vehicles include one or combinations of a train, a bus, a boat, and a plane. Examples of private transportation include various flexibly scheduled commuter vehicles such as an autonomous vehicle, a semi-autonomous vehicle, and a vehicle operated by a driver. Flexibly scheduled commuter vehicles allow for their route times to be specified in accordance with the needs of the passengers.

Private transport routing, e.g. car routing algorithms, and public transportation routing tend to differ as a result of the different properties of such networks, with the consequence that they cannot readily be integrated to provide a true multi-modal route planner. Previous attempts to obtain a multi-modal route involving both road and public transport networks involve using separate routings for public and private modes of transportation. See, e.g., U.S. 2016/0202079. U.S. 2016/0321566 discloses a grouping and routing method exclusively for private transport networks and provides no guidance to the passengers on the routing on the public transportation network. The recent publication “Hai Wang, Routing and Scheduling for a Last-Mile Transportation System, Transporation Science” is the first work to consider routing and scheduling optimization on the private transportation network. However, no mention is made on the optimization jointly over the public and private transportation networks.

Accordingly, there is a need to generate multi-modal routes, e.g. to allow a passenger to integrate their use of private transport and public transport between an origin and destination of interest, to provide a more efficient overall journey, and/or to reduce environmental impact.

### SUMMARY

The present disclosure relates to systems and methods for jointly controlling schedules of transport forming at least part of the multi-modal transportation network.

Embodiments of the present disclosure provide systems and methods for addressing problems of planning trips for passengers across multiple modes of transportation. Some embodiments provide a system and a method for controlling vehicles in a multi-modal transportation network including fixed schedule vehicles and commuter vehicles. Specifically, scheduling of passengers across two or more modes of transport consisting of: a first mode of a mass transportation network with fixed schedule vehicles, such as a air, boat, bus or train; and a second mode of a transportation network with flexibly scheduled commuter vehicles consisting of vehicles with smaller capacity such as cars operated by drivers, deriverless cars, minibuses, motorized platforms.

The fixed schedule vehicles have fixed schedules and unconstrained passenger capacities to transport a set of passengers between the transportation hubs of the corresponding service. For example, a train only transports passengers between train stations while the bus transports passengers between bus stops. As referred herein, the unconstrained passenger capacities can be understood as that of the maximum capacity of fixed schedule vehicles, which is not considered in the scheduling and controlling solution. In contrast, the commuter vehicles have unconstrained schedules, and a maximum passenger capacity to transport the passengers to or from the transportation hub via a route that is chosen according to the destinations of the passengers.

According to embodiments of the present disclosure, at least one example of the planning problem, can include users commuting to a location, for example, places of employment, located in an industrial park situated near a train station. Wherein buildings in the industrial park may be reached from the train station using commuter vehicles that have a limited number of seating for passengers. The commuter vehicles can be autonomous or be operated by a person. A typical usage scenario may include, first, all the passengers place a request, e.g., through their mobile devices or computers, ahead of time (prior to boarding), for a transportation service that provides a fixed scheduling system. The request can include an originating station or an initial starting location, a destination building or target final location and a time window of arrival at the destination. Next, the scheduling system can aggregate the requested information from the users, determine individual schedules for all the user's requests, jointly, and can communicate the schedules to the users. The exemplar schedule for one or more of the users may include a time the user should board the train; an identification number of the commuter vehicle assigned to the specific user; and a times of service of that commuter vehicle.

In the above usage scenario, the total travel time for the passenger is a sum of the travel time in train, time spent waiting for the assigned commuter vehicle at the train station and the time spent traveling in the commuter vehicle to reach the destination. At least one goal of the scheduling system, among many goals, is to determine a passenger's schedule to minimize a total travel time for all users. The number of commuter vehicles available at a station can be limited. In performing the scheduling for the users, the system also determines additional users that ride together in the commuter vehicles to reach their destinations.

Some embodiments of the present disclosure are based on recognition that joint optimization over multiple transport modes for all users should take into consideration attempts to obtain a social optimum as opposed to individual optimum. For example, a method can be beneficial to each individual user and for all users, if such a scheduling and controlling of the multi-modal transportation network achieves a system optimization, or provides for a societal optimization that jointly optimizes all the passengers. In contrast with providing conventional methods that optimize, personalize schedules for each individual passenger, the present disclosure provides for joint optimization that can include an effect of scheduling a trip for one passenger based on schedules of other passengers. To that end, some embodiments of the present disclosure jointly optimize total travel time of all passengers to address the mutual influence in the schedules.

However, such a joint optimization is a computationally difficult problem, especially when the solution takes into consideration the desired arrival time windows of the passengers when computing the schedules. The inclusion of arrival time windows in the scheduling, affords passengers a degree of control on the arrival time at their destination and allows system flexibility in computing a feasible solution.

Some embodiments of the present disclosure are based on realization that computational difficulties of the joint schedule optimization can be reduced by decoupling scheduling of the fixed schedule vehicles and commuter vehicles. Specifically, some embodiments identify individual groups of the passengers to obtain a set of groups of passengers. Wherein, each group includes a number of passengers not exceeding a maximum passenger capacity of any commuter vehicles for commuter vehicles used for any predetermined route specific to an arriving location. Further, each group is also associated with a set of schedules including combinations of starting times and corresponding routes from the set of routes that allow to transport all passengers in the group, from the intermediate location to their target locations, or from their initial locations to the intermediate location within the requested time windows. We realized that such a grouping can decouple the scheduling of different modes of transportation, because the grouping of the passengers can be performed without considering schedules of the fixed schedule vehicles or the commuter vehicles and without considering the total travel time of the passengers, among other things.

After the passengers are grouped according to their needs, some embodiments assign each group to a commuter vehicle leaving or reaching the intermediate location, according to a schedule from the set of schedules associated with the group. The assigning of each group is by optimizing jointly a function of a total travel time of the set of passengers from the initial location to the target location, subject to satisfying the resource limits on the number of commuter vehicles and the arrival time-windows of passengers associated with each group. The resource limits on the commuter vehicle ensures that time-period over which a vehicle serves a particular group does not overlap with the service periods of another group. The route choice and start time determine the time period for which a commuter vehicle serves a group. The route choice and start time for the commuter vehicle determine if the passengers in the group can reach their destination within the time-windows and also determine the travel time for the passengers to reach the destination. The specification of the start time for a passenger on the commuter vehicle determines the set of routes on the fixed schedule vehicles using which the passenger can reach the intermediate location.

Notably, the assignments of the groups considers the total travel time of the passengers, but reduces search space by: (i) limiting the set of possible starting time for the group to reach their destination based on the destination time-windows of the passengers in the group and possible route choices on the commuter vehicle and (ii) limiting the set of possible route choices on the fixed schedule vehicles to ones that allows the passengers to reach the intermediate location by the start time of the commuter vehicle. Thus, the grouping of passengers can significantly reduce the complexity of the joint optimization and improve the performance of the scheduling processor.

Given an assignment of passengers into groups, the present disclosure provides for an algorithm that can determine if optimal schedule for passengers across all modes of transportation if there exists a schedule for all passengers so that time-windows of arrival are satisfied. If the problem is infeasible then the algorithm terminates with a certificate of infeasibility.

At least some benefits of the present disclosure for passengers include obtaining a schedule for them to travel over multiple modes of transportation that is seamless. Such a schedule reduces passenger anxiety and provides the passenger with accurate estimations of waiting times between the different modes of transport. As noted above, the present disclosure came to several realizations, which included: (1) limiting passenger group sizes so as not to exceed the seating capacity of commutor vehicles, wherein, in creating the groups of passengers, care is taken to ensure that there exist commutor vehicles routes that allows all passengers in the group to reach their destination in specified arrival time window; (2) given a grouping of the commutor vehicles, a joint optimization can be performed to determine the train times and the commutor vehicles start times for the individual group, so that the passenger's total travel times can be minimized; (3) Further, the above procedures (1) and (2) can be iterated by picking other passenger groupings, and the process of picking groupings can continue until such time that the schedules have to be communicated to the passengers or the change in the total travel time over successive groupings is below a threshold, until the computational budget is exceeded, or an improvement in the total travel times is below a threshold.

At least one aspect of the present disclosure includes achieving a system optimum or societal optimum, by jointly optimizing for all the passengers. Whereas, conventional scheduling methods for passenger travels over multiple modes of transportation all focus on providing optimized, personalized schedules for the individual. At least one other aspect of the present disclosure includes taking into consideration desired arrival time windows of the passengers when computing the schedules. Specifically, the inclusion of arrival time windows in the scheduling can afford passengers a degree of control on an arrival time at their destination. In addition, the present disclosure allows for system flexibility in computing a good solution

According to an embodiment of the present disclosure, a system for controlling vehicles in a multi-modal transportation network having fixed schedule vehicles and commuter vehicles. The system including a receiver to receive a request for transportation from passengers in a set of passengers. Wherein each request from the passenger includes an initial location, a target location, and a time window for arriving at a target location or leaving an initial location. A processor in communication with the receiver, that is configure to jointly optimize travel times of the set of passengers to reach their corresponding target locations. Wherein the joint optimization is based on identifying groups of passengers from the set of passengers to obtain a set of groups of passengers. Such that, each group is associated with a set of schedules including combinations of starting times of the fixed schedule vehicles and the commuter vehicles, and corresponding routes from a set of predetermined routes that transport all passengers in the group, within the requested time windows. Wherein each group includes a number of passengers not exceeding a maximum passenger capacity of commuter vehicles transporting passengers. Assign an identified group to a commuter vehicle leaving or reaching the intermediate location. Wherein each passenger is assigned to a fixed schedule vehicle reaching the intermediate location prior to the departure of the commuter vehicle, or leaving the intermediate location after the arrival of the commuter vehicle, according to a schedule from the set of schedules associated with the identified group, by optimizing jointly a function of a total travel time of the set of passengers, from the initial location to the target location subject to constraints on transporting each group of passengers together, according to at least one schedule of the set of schedules associated with each group, so as to obtain an assigned travel itinerary for each passenger. A transmitter in communication with the processor, to transmit to each passenger their assigned travel itinerary in the multi-modal transportation network.

According to another embodiment of the present disclosure, a method for controlling vehicles in a multi-modal transportation network having fixed schedule vehicles and commuter vehicles. Wherein the fixed schedule vehicles have fixed schedules and unconstrained passenger capacities to transport a set of passengers to, or from, an intermediate location. Wherein the commuter vehicles have unconstrained schedules and a maximum passenger capacity to transport the passengers to, or from, the intermediate location, via at least one route selected from a set of predetermined routes. The method including receiving via a receiver a request for transportation from passengers in the set of passengers, each request from a passenger includes an initial location, a target location, and a time window for arriving at the target location, or leaving the initial location, and storing the received request in a memory. Using a processor in communication with the receiver and the memory, that is configure to jointly optimize travel times of the set of passengers to reach their corresponding target locations. Wherein the joint optimization is based on identifying groups of passengers from the set of passengers to obtain a set of groups of passengers, such that each group is associated with a set of schedules including combinations of starting times of the fixed schedule vehicles and the commuter vehicles, and corresponding routes from a set of predetermined routes that transport all passengers in the group, within the requested time windows. Wherein each group includes a number of passengers not exceeding the maximum passenger capacity of commuter vehicles transporting passengers. Assign an identified group to a commuter vehicle leaving or reaching the intermediate location. Wherein each passenger is assigned to a fixed schedule vehicle reaching the intermediate location prior to the departure of the commuter vehicle, or leaving the intermediate location after the arrival of the commuter vehicle, according to a schedule from the set of schedules associated with the identified group, by optimizing jointly a function of a total travel time of the set of passengers, from the initial location to the target location subject to constraints on transporting each group of passengers together, according to at least one schedule of the set of schedules associated with each group, so as to obtain an assigned travel itinerary for each passenger. A transmitter in communication with the processor, to transmit to each passenger their assigned travel itinerary in the multi-modal transportation network.

According to another embodiment of the present disclosure, a non-transitory computer readable storage medium embodied thereon a program executable by a computer for performing a method. The method is for controlling vehicles in a multi-modal transportation network having fixed schedule vehicles and commuter vehicles. The method including receiving via a receiver a request for transportation from passengers in the set of passengers, each request from a passenger includes an initial location, a target location, and a time window for arriving at the target location, or leaving the initial location, and storing the received request in a memory. Using a processor in communication with the receiver and the memory, that is configure to jointly optimize travel times of the set of passengers to reach their corresponding target locations. Wherein the joint optimization is based on identifying groups of passengers from the set of passengers to obtain a set of groups of passengers, such that each group is associated with a set of schedules including combinations of starting times of the fixed schedule vehicles and the commuter vehicles, and corresponding routes from a set of predetermined routes that transport all passengers in the group, within the requested time windows. Wherein each group includes a number of passengers not exceeding the maximum passenger capacity of commuter vehicles transporting passengers. Assign an identified group to a commuter vehicle leaving or reaching the intermediate location. Wherein each passenger is assigned to a fixed schedule vehicle reaching the intermediate location prior to the departure of the commuter vehicle, or leaving the intermediate location after the arrival of the commuter vehicle, according to a schedule from the set of schedules associated with the identified group, by optimizing jointly a function of a total travel time of the set of passengers, from the initial location to the target location subject to constraints on transporting each group of passengers together, according to at least one schedule of the set of schedules associated with each group, so as to obtain an assigned travel itinerary for each passenger. A transmitter in communication with the processor, to transmit to each passenger their assigned travel itinerary in the multi-modal transportation network.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A is a block diagram illustrating a method for jointly controlling schedules of transport forming at least part of the multi-modal transportation network, according to an embodiment of the present disclosure;

FIG. 1B is a schematic illustrating some components of the method of FIG. 1A, according to embodiments of the present disclosure;

FIG. 1C is a flow diagram of the method of FIG. 1A, for grouping and assigning vehicles to passengers, according to embodiments of the present disclosure;

FIG. 1D is a flow diagram of the method of FIG. 1A, for grouping and assigning vehicles to passengers, according to embodiments of the present disclosure;

FIG. 1E is a flow diagram of the method of FIG. 1A showing the steps for determining a groupings of passengers, according to embodiments of the present disclosure;

FIG. 1F is a flow diagram of the method of FIG. 1A showing the steps for determining a feasible group for a passenger, according to embodiments of the present disclosure;

FIG. 1G is a flow diagram of the method of FIG. 1A showing the steps for determining a best group for a passenger, according to embodiments of the present disclosure;

FIG. 2A is a schematic illustrating the system by which passenegers communciate with the scheduler and receive their schedules, according to embodiments of the present disclosure;

FIG. 2B is a schematic illustrating the time-window requests from passengers and a route in the commuter vehicle that delivers the passengers in their destination but is not feasible, according to embodiments of the present disclosure;

FIG. 2C is a schematic illustrating the time-window requests from passengers and a route in the commuter vehicle that delivers the passengers in their destination and is feasible, according to embodiments of the present disclosure;

FIG. 2D is a schematic illustrating the system by which passenegers communciate with the scheduler's website and receive their schedules upon entering their information on the scheduler's website, according to embodiments of the present disclosure;

FIG. 3A is a block diagram of illustrating, the flowchart of a method of FIG. 1A where the method continues to search for other passenger groupings, according to embodiments of the present disclosure;

FIG. 3B is a block diagram illustrating the method of FIG. 1A, describing the inputs to the binary optimization algorithm for determining the optmal scheduling for a given set of groupings, according to embodiments of the present disclosure;

FIG. 3C is a block diagram illustrating the method of FIG. 1A, describing the formulation of the binary optimization problem for determining the optimal scheduling for a given set of groupings, according to embodiments of the present disclosure;

FIG. 3D is a block diagram illustrating the method of FIG. 1A, describing the algorithm for recovering the assignments of commuter vehicles to groups from the solution of the binary optimization problem, according to embodiments of the present disclosure;

FIG. 3E and FIG. 3F are block diagrams illustrating the method of FIG. 1A, describing the algorithm for breaking a given groupings of passengers into more groupings of passengers in an effort to reduce the waiting times that a passengers causes other passengers in the group, according to embodiments of the present disclosure;

FIG. 3G and FIG. 3H are block diagrams illustrating the method of FIG. 1A, describing the algorithm for reducing the number of groups introduced by the algorithm in FIGS. 3E and 3F; and

FIG. 4 is a block diagram of illustrating the method of FIG. 1A, that can be implemented using an alternate computer or processor, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Overview

The present disclosure relates to systems and methods for jointly controlling schedules of transport forming at least part of the multi-modal transportation network.

The embodiments of the present disclosure provide systems and methods for addressing problems of planning trips for passengers across multiple modes of transportation. Some embodiments provide a system and a method for controlling vehicles in a multi-modal transportation network including fixed schedule vehicles and commuter vehicles. Specifically, scheduling of passengers across two or more modes of transport consisting of: a first mode of a mass transportation network with fixed schedule vehicles, such as a airplane, boat, bus or train; and a second mode of a transportation network with commuter vehicles consisting of vehicles with smaller capacity such as cars, vans, pods or motorized platforms that are either driven by a person or are autonomous.

The fixed schedule vehicles can have schedules that can be adapted to the needs of the passengers and unconstrained passenger capacities to transport a set of passengers to or from an intermediate location. As referred herein, the unconstrained passenger capacities can be understood as that of the maximum capacity of scheduled vehicles, which is not considered in the scheduling and controlling solution. In contrast, the commuter vehicles that can have unconstrained schedules, and a maximum passenger capacity to transport the passengers to or from the intermediate location via one of a route selected from a set of predetermined routes.

In addressing the problems of planning trips for passengers across multiple modes of transportation, the present disclosure considers passengers traveling from a set of stations for the fixed schedule vehicles to a set of buildings, to arrive at a time. There are a set of commuter vehicles (CVs), that take the passengers from or to their destination buildings. At least one aspect is to plan the schedules for the requests by passengers, so as to satisfy their arrival time windows. Another embodiment of the disclosure, consider passengers traveling from buildings to a set of of stations for fixed schedule vehicles where the passengers desire to leave the buildings by a certain time.

A realization of the present disclosure includes that once the groups of passengers that share a CV are specified then, the scheduling of the fixed schedule vehicles and CVs can be decoupled. In order to come to a solution to the problem, the solution process can include a first step defining a group as a subset of passengers numbering less than a capacity of the CV that ride together to reach their destinations. In grouping the passengers, the present disclosure also ensures that there exists at least one route for the CV and a start time for that route, such that the arrival deadline of all the passengers can be satisfied. Such that, this determination is able to be performed efficiently, since the routes that a CV can take are typically a small number routes. Further, in the first step the present disclosure can determine a partitioning of passengers into groups that share a CV to reach their destination, i.e. building, from the train station, i.e. train terminal.

In the second step, given the set of groups, the second step determines for each group: (i) an assignment of CV to that group; and (ii) a time at which the group leaves the train station or train terminal, on the assigned CV. In doing so, the present disclosure process ensures that the number of CVs that are in operation at any time does not exceed a maximum number of CVs.

Further, the optimization problem in this second stage can be an instance of a Binary Optimization Problem. Wherein we realized that in this formulation is that it is tight (optimality gap at the root node is very small) and is typically solved in fractions of a second. Which makes the solution of the second step, efficient and also allows for rapid exploration of the search space. Further, the determination of the infeasibility of the groups also occurs in a fractions of a second.

Regarding, a third step, if a set of feasible schedules are obtained then, the process can stop, or a different set of groups can be chosen by repeating the first and second steps.

For example, if the second step does not yield a feasible schedule for the groups, then the present disclosure relaxes the arrival time windows of the groups. The relaxation of time windows can be obtained by decreasing the earliest time of arrival and increasing the latest time of arrival for all the groups. With this choice of time windows, the first and second steps can be repeated. If the problem is still infeasible then the time windows can be relaxed further and the procedure continues until a feasible solution is obtained.

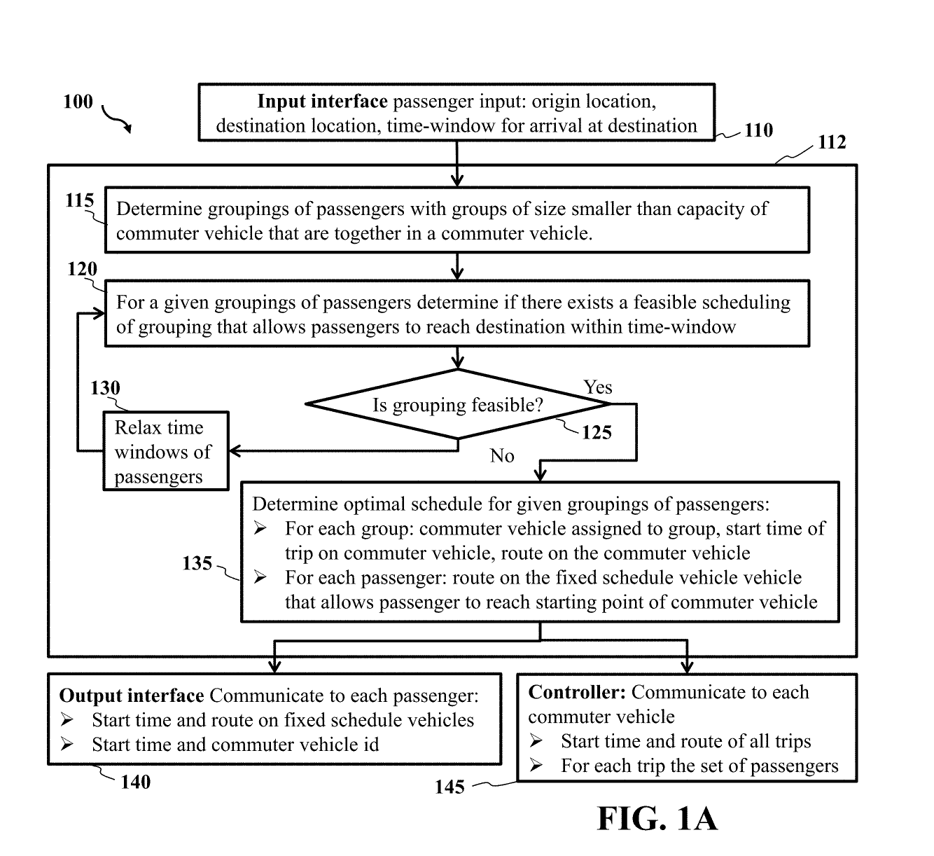

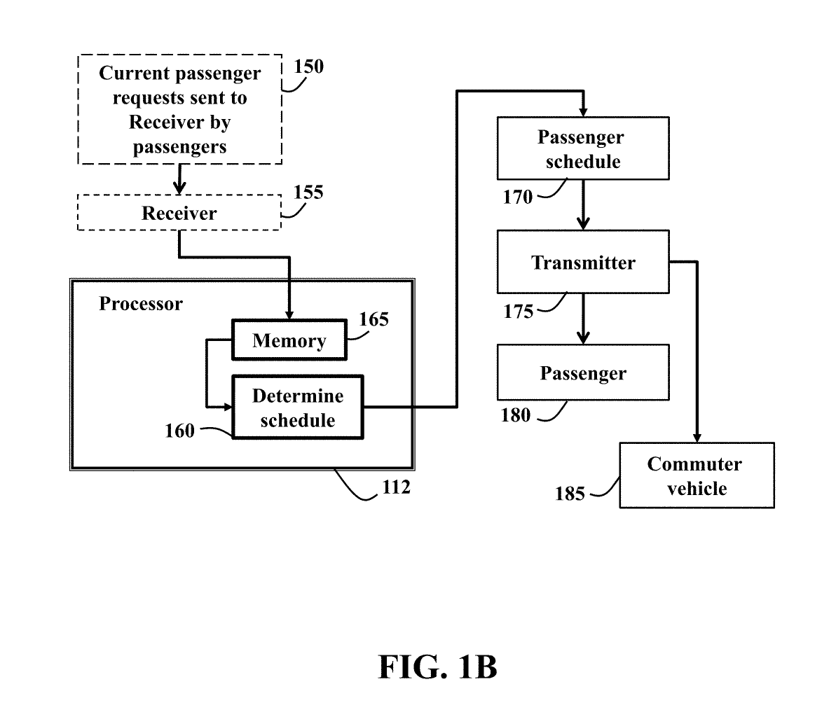

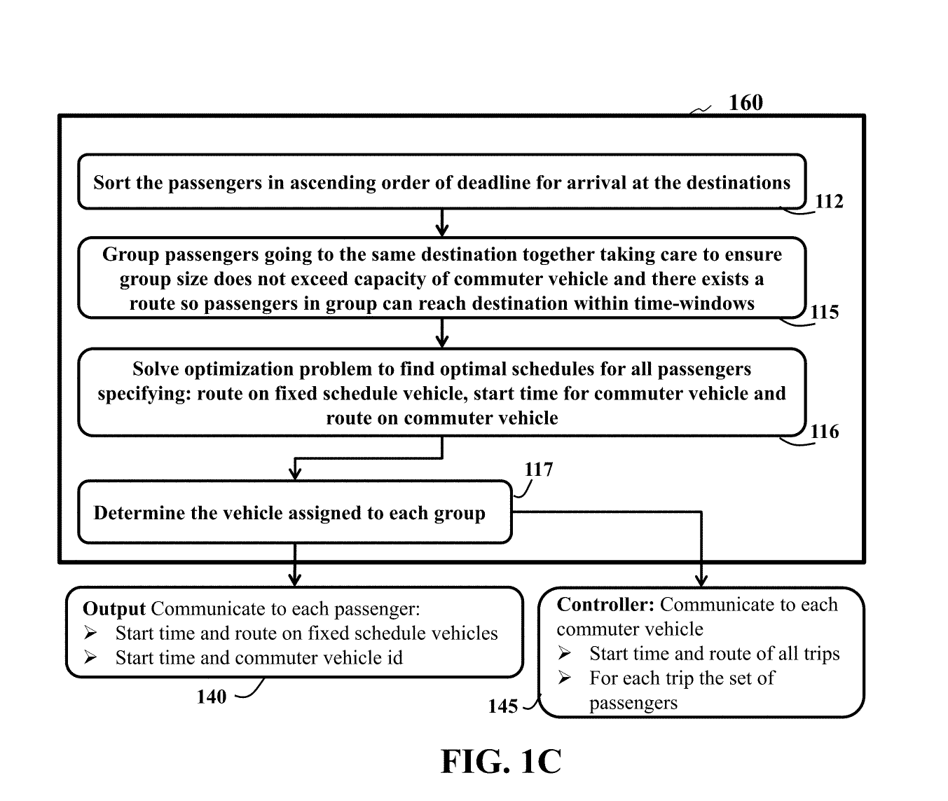

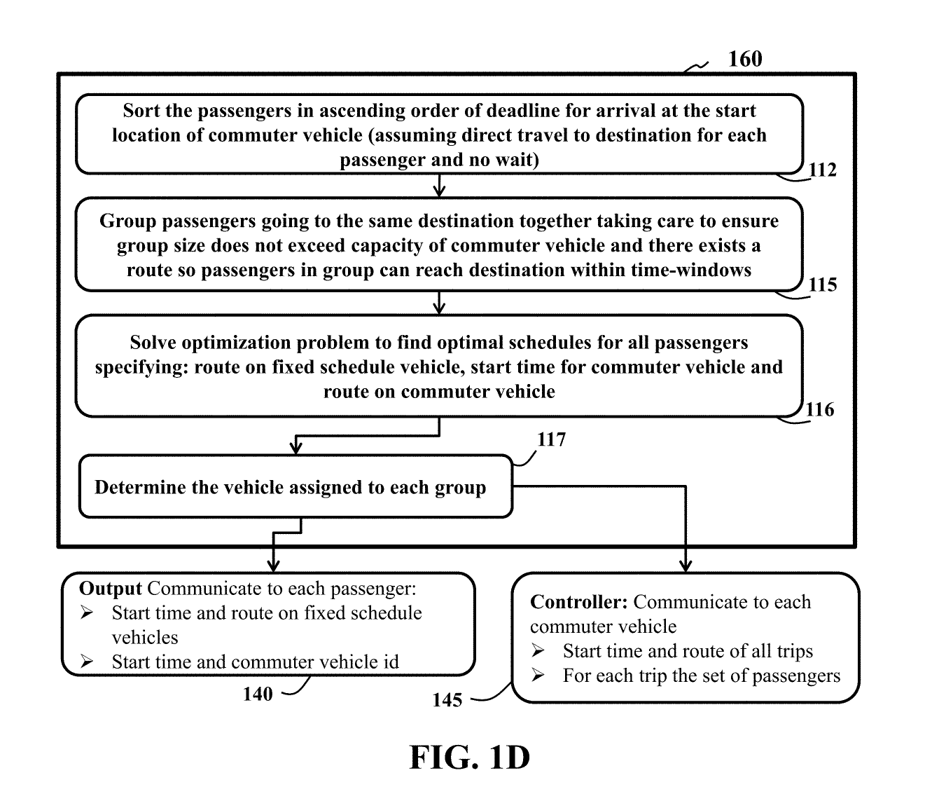

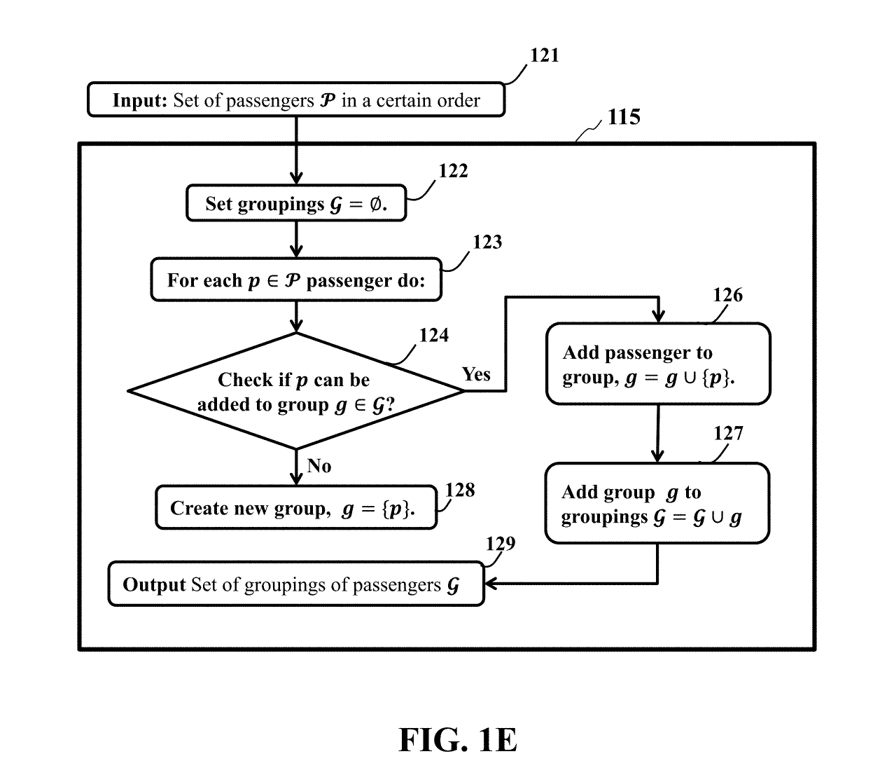

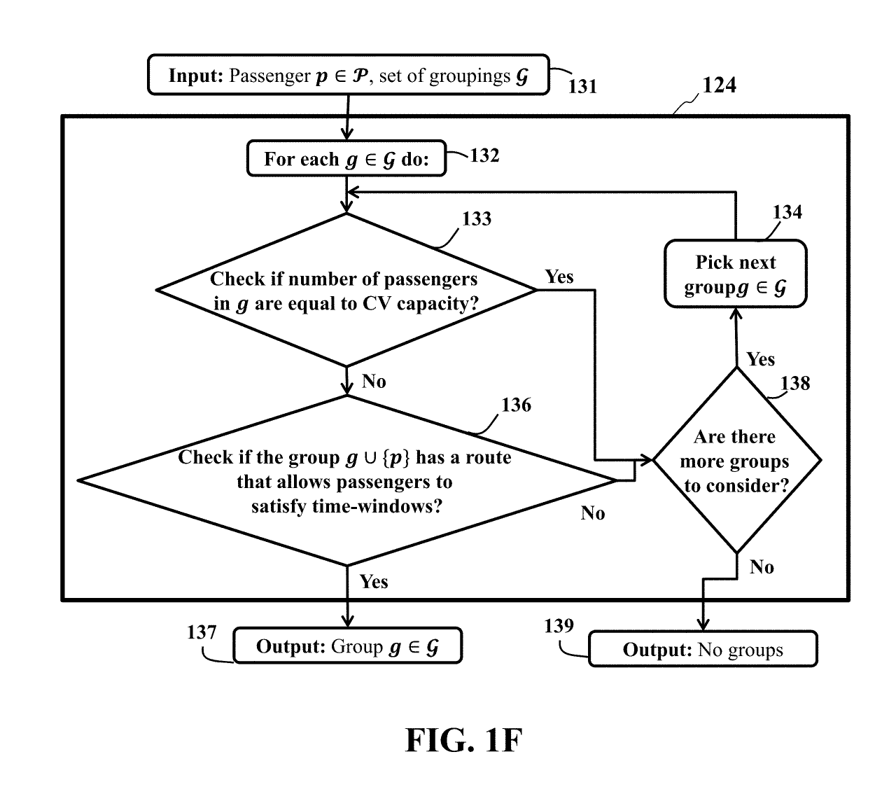

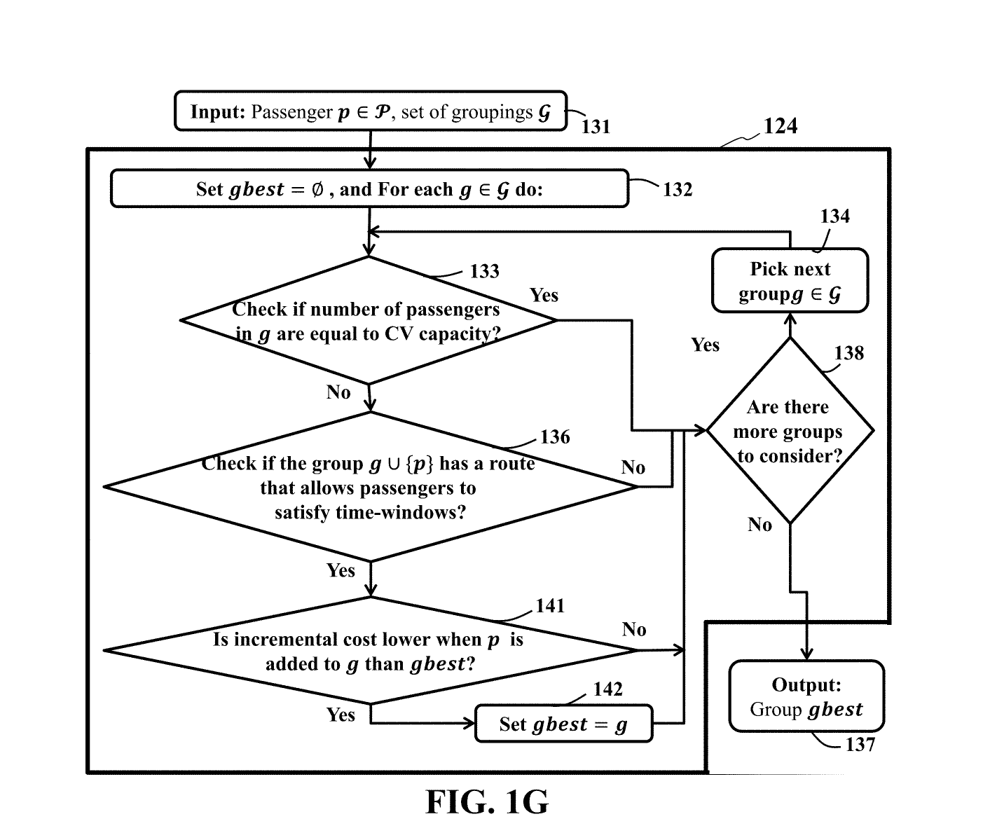

FIG. 1A is a block diagram illustrating a method for jointly controlling schedules of transport forming at least part of the multi-modal transportation network, according to an embodiment of the present disclosure. An input interface 110 to obtain the passengers information on their station of origin, destination building and time-window for arrival at the destination is provided. The system then determines a grouping of passengers 115 such that every group of passengers numbers less than the capacity of the CV; and there exists at least one start time and route for the group such all the passengers can reach their destinations within the specified time-windows. Using the groupings of passengers 115, the method determines if the groups can be feasibly scheduled 120 on CVs while satisfying the restrictions on the number of CVs that are available and that all passengers reach their destinations in the desired time-windows. If the groups cannot be scheduled on the CVs 125 then the time-windows of the passengers are increased for example by a factor of 2. The method repeats the process of determining a feasible schedule for CVs 120. If the groups can be feasibly scheduled, then the method terminates with an optimal schedule 135 for the passengers and CVs that minimizes the total travel time for all the passengers. The method communicates to the passengers 140 the start time of the passengers from the origin stations, the route on the fixed schedule vehicle, the commuter vehicle assigned for their journey, the start time on the commuter vehicle and the time of arrival at the destination. The methods can communicate 145 to the commuter vehicles the start times of trips, the routes on each of the trips and the set of passengers on each of the trips.

FIG. 1B is a schematic illustrating some components of the method of FIG. 1A, according to embodiments of the present disclosure. The current set of passengers requests 150 are sent to receiver by passengers. The receiver 155 obtains the information from the passengers and transmits this to scheduler 160. The scheduler 160 is implemented on a processor and is provisioned with memory 165 which stores the information on the passenger requests. The scheduler determines the schedule for the passengers 170 and then sends the information to the transmitter 175. The transmitter 175 transmits the information on the passenger's schedules to the passengers 180 and the commuter vehicles 185.

FIG. 1C is a flow diagram of the method of FIG. 1A, for grouping and assigning vehicles to passengers, according to embodiments of the present disclosure.

The set of passengers are sorted 112 for instance in the ascending order of the deadline of arrival at the building. Based on this ordering, the passengers are grouped 115 into sets of passengers not exceeding the capacity of the commuter vehicle. The grouping of passengers ensures that for each group there exists a start time and a corresponding route that allows all the passengers to reach their destinations within the specified time-windows. Using the groupings 115, the method formulates a binary optimization problem to determine 116 the optimal schedule for the passengers so that their total travel is minimized. If the problem is feasible and an optimal schedule is obtained, then the method determines the appropriate vehicle that is assigned to each group 117. The method communicates the optimal schedule to the passengers 140 and the commuter vehicles 145.

FIG. 1D is a flow diagram of the method of FIG. 1A, for grouping and assigning vehicles to passengers, according to embodiments of the present disclosure.

The set of passengers are sorted 112 for instance in the ascending order of the deadline of arrival at the station from which the passengers board the commuter vehicles. To compute the deadline, the passengers are assumed to travel directly to their destination by the shortest path and spend no time waiting for the commuter vehicles. Based on this ordering, the passengers are grouped 115 into sets of passengers not exceeding the capacity of the commuter vehicle. The grouping of passengers ensures that for each group there exists a start time and a corresponding route that allows all the passengers to reach their destinations within the specified time-windows. Using the groupings 115, the method formulates a binary optimization problem to determine 116 the optimal schedule for the passengers so that their total travel is minimized. If the problem is feasible and an optimal schedule is obtained, then the method determines the appropriate vehicle that is assigned to each group 117. The method communicates the optimal schedule to the passengers 140 and the commuter vehicles 145.

FIG. 1E is a flow diagram of the method of FIG. 1A showing the steps for determining a groupings of passengers, according to embodiments of the present disclosure.

The method takes as input 121 an ordering of the passengers that are requesting service. The initial set of groupings 122 is set to be empty. For each passengers in the list of passengers 123, the method checks 124 if the passenger can be added to one of the existing groups. If the passenger cannot be added to any group then a new group with the passengers as the only member of the group 128 is created. The new group is appended to the set of existing groups. If the passengers can be added to an existing group then the passenger is added to that group 126. The method picks the next passenger 123 and the method continues until all passengers have been provided a group. The set of groupings 129 is obtained and is then provided to the method for determing optimal schedules 120.

FIG. 1F is a flow diagram of the method of FIG. 1A showing the steps for determining a feasible group for a passenger, according to embodiments of the present disclosure.

Given a particular passenger and set an existing set of groupings 131, the method determines that there exists a group to which the passenger can be added or determines that there exists no group in the set of groupings. The method picks a group 132 and checks if the passenger can be added to the group. First, the method checks 133 if the addition of the passenger results in a group whose size exceeds the capacity of the commuter vehicle. If the size restriction is violated then the method considers the group 134 as lng as there are groups 138 that have not been previously considered. If the size restriction if not violated by the addition of the passengers to the group, then the method checks 136 if the group formed by addition of the passenger has a route that allows passengers to reach their destinations within their time-windows. If there exists no route then the method considers the next group 134 if additional groups exists 138 that have not been considered previously. If the the group has a feasible route then the method terminates 137 with the group. If the method finds that no group exists and there are no additional groups exists 138 to be considered then the method terminates without any group 139.

FIG. 1G is a flow diagram of the method of FIG. 1A showing the steps for determining a best group for a passenger, according to embodiments of the present disclosure.

Given a particular passenger and set an existing set of groupings 131, the method determines the best group to which the passenger can be added or determines that there exists no group in the set of groupings. The method picks a group 132, set the best grouping to be empty and checks if the passenger can be added to the group. First, the method checks 133 if the addition of the passenger results in a group whose size exceeds the capacity of the commuter vehicle. If the size restriction is violated then the method considers the group 134 as lng as there are groups 138 that have not been previously considered. If the size restriction if not violated by the addition of the passengers to the group, then the method checks 136 if the group formed by addition of the passenger has a route that allows passengers to reach their destinations within their time-windows. If there exists no route then the metho considers the next group 134 if additional groups exists 138 that have not been considered previously. If the the group has a feasible route then the method checks 141 if the addition of the passenger to the group results in lower total cost compared to adding to the best group. If the increase in the objective is lower compared to the existing best group then the method assigns the new group 142 as the best group. If the method finds that no group exists and there are no additional groups exists 138 to be considered then the method terminates 137 with the best group, given a grouping of passengers.

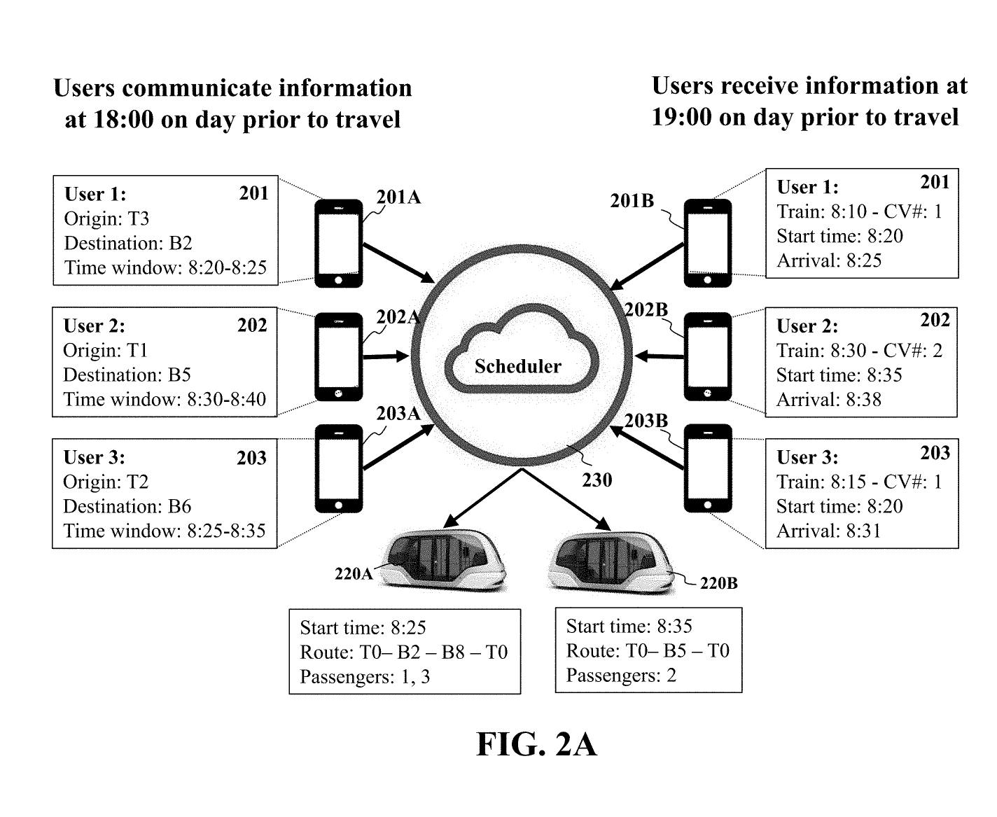

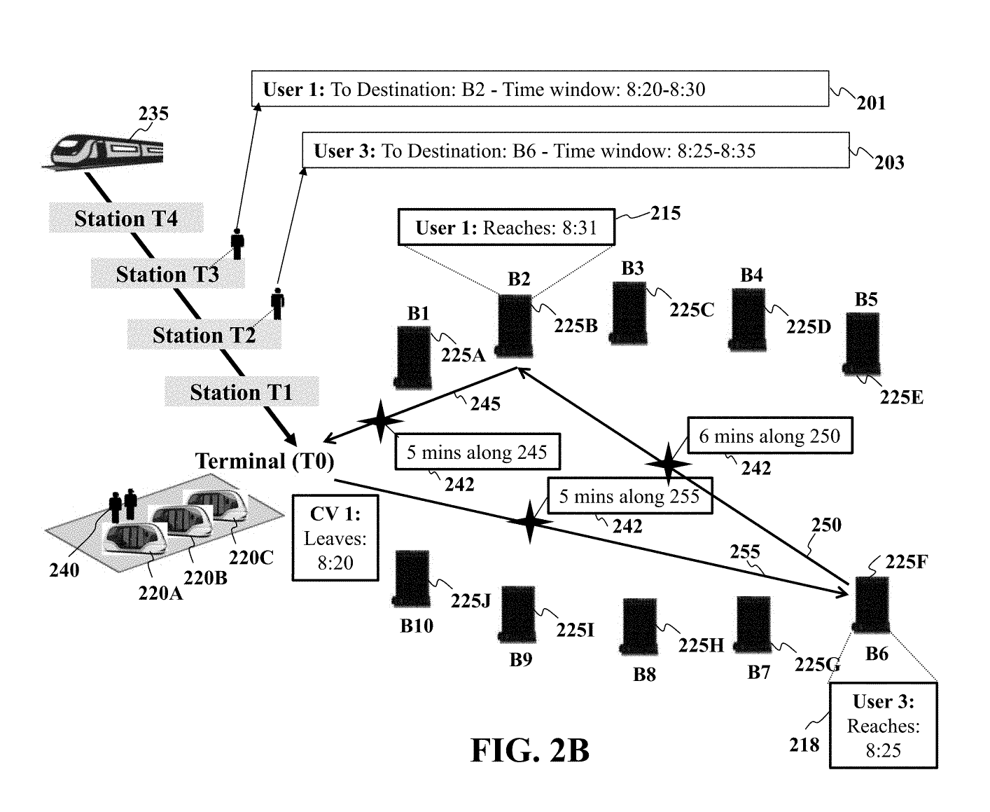

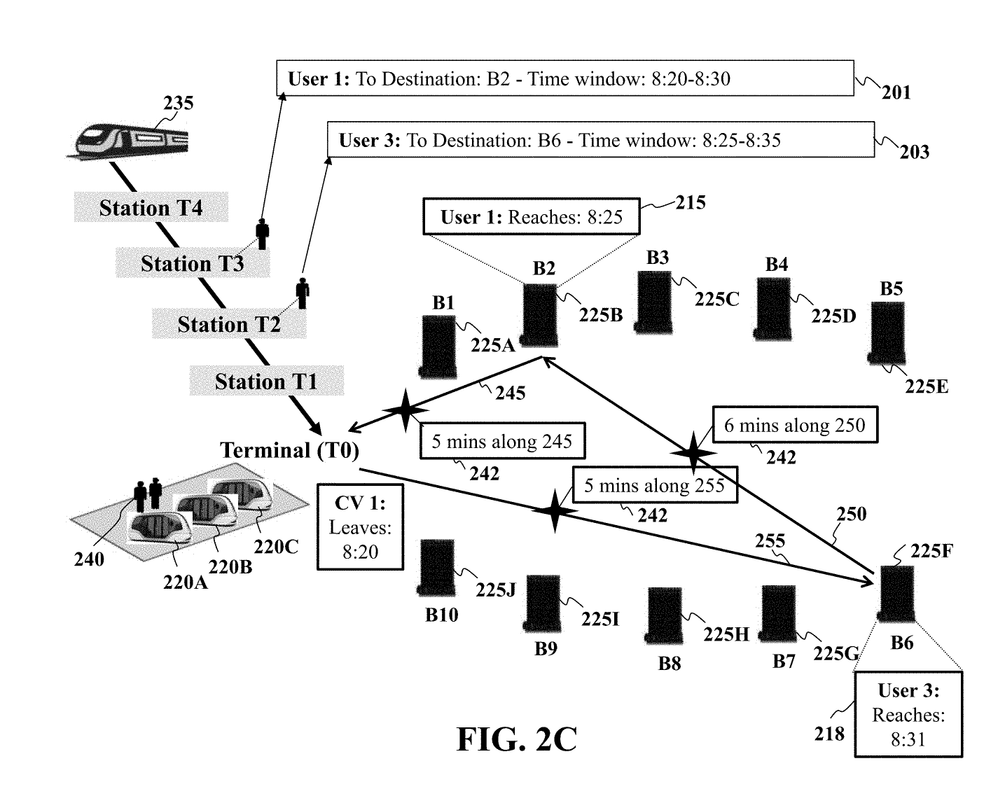

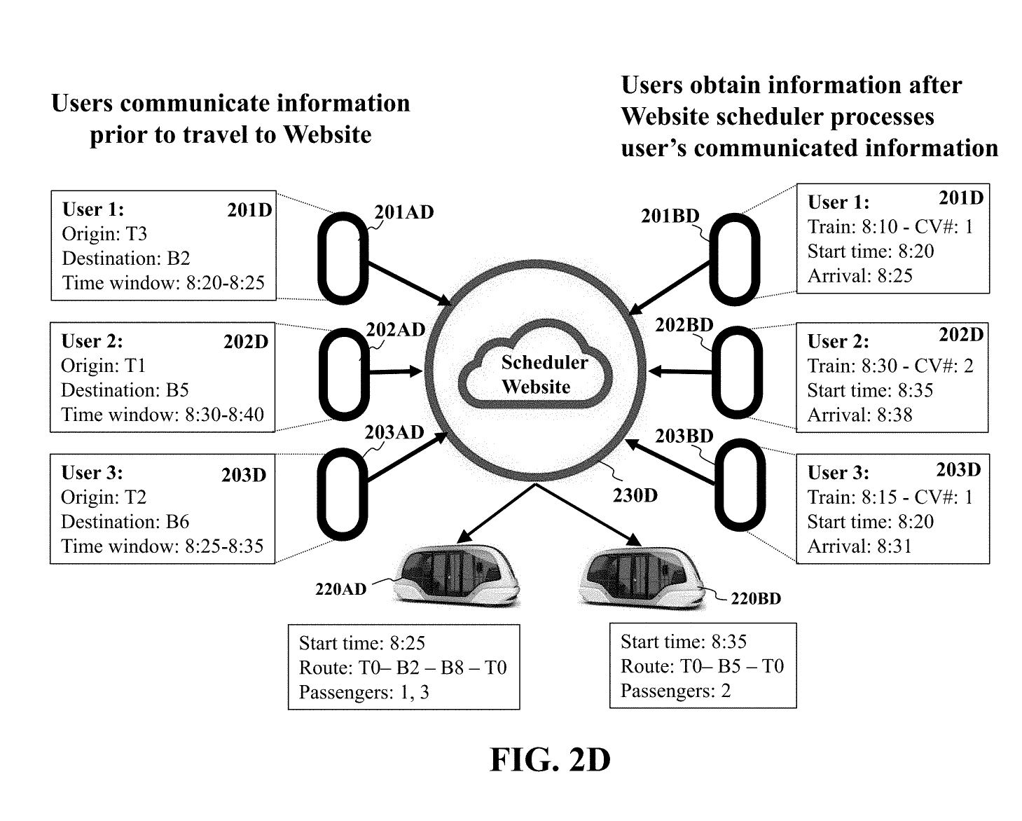

FIG. 2A is a schematic illustrating the system by which passenegers communciate with the scheduler and receive their schedules, according to embodiments of the present disclosure.

The users 201, 202, 203 provide input to the scheduling system 230 requesting the origin station, destination building and the time-window for arrival at the destination. Each user 201, 202, 203 communicates to the scheduler 230 using their individual smart-phones or computer 201A, 202A, 203A. The scheduler 230 determines the schedule for the users and the commuter vehicles 220. The scheduler 230 communicates the optimal schedule for all passengers 210 through the preferred communication device such as a smartphone 210 or computer. The user receives information on the train time on which the passenger leaves station of origin, the id of the commuter vehicle that the user travels on, and the start and arrival times for the journey in the commuter vehicle. The scheduler communicates to the commuter vehicles 220 the start time of the trips, the routes that the commuter vehicles take and the information on the passengers that are transported in those trips.

FIG. 2B is a schematic illustrating the time-window requests from passengers and a route in the commuter vehicle that delivers the passengers in their destination but is not feasible, according to embodiments of the present disclosure.

The fixed schedule vehicle 235 depicted in the figure as a train transports passengers from the stations of origin and brings them to the station from which the commuter vehicles serve the passengers. The commuter vehicles 220 are parked at a station for the fixed schedule vehicles. The passengers request to reach their destination buildings 225 from the station Terminal (T0). A possible route 245 for two passengers User 1, User 3 in which the commuter vehicle leaves the Terminal (T0) at 8:20. The commuter vehicle proceeds to building B6 which is the destination of User 3 reaching the building at 8:25. The commuter vehicle then proceeds to Building B2 which is the destination of User 1, reaching the building at 8:31. The commuter vehicle then returns to the Terminal (T0) at 8:36. The route does not allow the User 1 to reach the destination building B2 in the desired time-window while the User 3 reached the time destination building B6 in the desired time-window. The route choice and start time is not feasible for the passengers Users 1,3.

FIG. 2C is a schematic illustrating the time-window requests from passengers and a route in the commuter vehicle that delivers the passengers in their destination and is feasible, according to embodiments of the present disclosure.

The fixed schedule vehicle 235 depicted in the figure as a train transports passengers from the stations of origin and brings them to the station from which the commuter vehicles serve the passengers. The commuter vehicles 220 are parked at a station for the fixed schedule vehicles. The passengers request to reach their destination buildings 225 from the station Terminal (T0). A possible route 250 for two passengers User 1, User 3 in which the commuter vehicle leaves the Terminal (T0) at 8:20. The commuter vehicle proceeds to building B2 which is the destination of User 1 reaching the building at 8:25. The commuter vehicle then proceeds to Building B6 which is the destination of User 3, reaching the building at 8:31. The commuter vehicle then returns to the Terminal (T0) at 8:36. The route allows both the Users 1,3 to reach their respective destination building B2, B6 in the desired time-windows. The route choice and start time is feasible for the passengers Users 1,3.

FIG. 2D is a schematic illustrating the system by which passenegers communciate with the scheduler's website and receive their schedules upon entering their information on the scheduler's website, according to embodiments of the present disclosure.

The users 201D, 202D, 203D provide input to the scheduling system 230D that is associated with a scheduler website. The users 201D, 202D, 203D access the scheduler website via computer, tablet, smartphone and the like, input their information including requesting an origin station, a destination building and a time-window for arrival at the destination. Each user 201D, 202D, 203D can communicate to the scheduler 230D using their individual smart-phones or computer 201AD, 202AD, 203AD. The scheduler 230D determines the schedule for the users and the commuter vehicles 220AD, 220BD. The scheduler 230D communicates the optimal schedule for each user 201AD, 202AD, 203AD through their preferred communication device(s). Each user 201AD, 202AD, 203AD receives information on their train time on which they leave their station of origin, an identify of the commuter vehicle that they are to travel on, and a start and arrival times for their journey in the commuter vehicle. The scheduler communicates back to each user, their commuter vehicles 220D the start time of the trips, the routes that the commuter vehicles take and the information on the passengers that are transported in those trips. At least one aspect, of many aspects of the present embodiment, is that users are able to obtain their travel request information quickly.

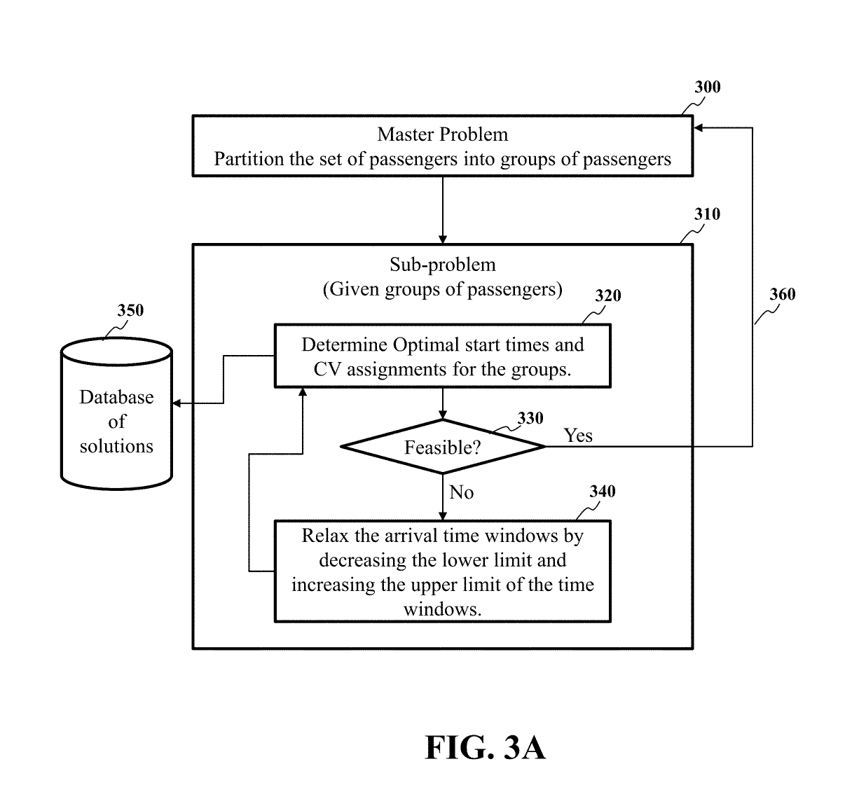

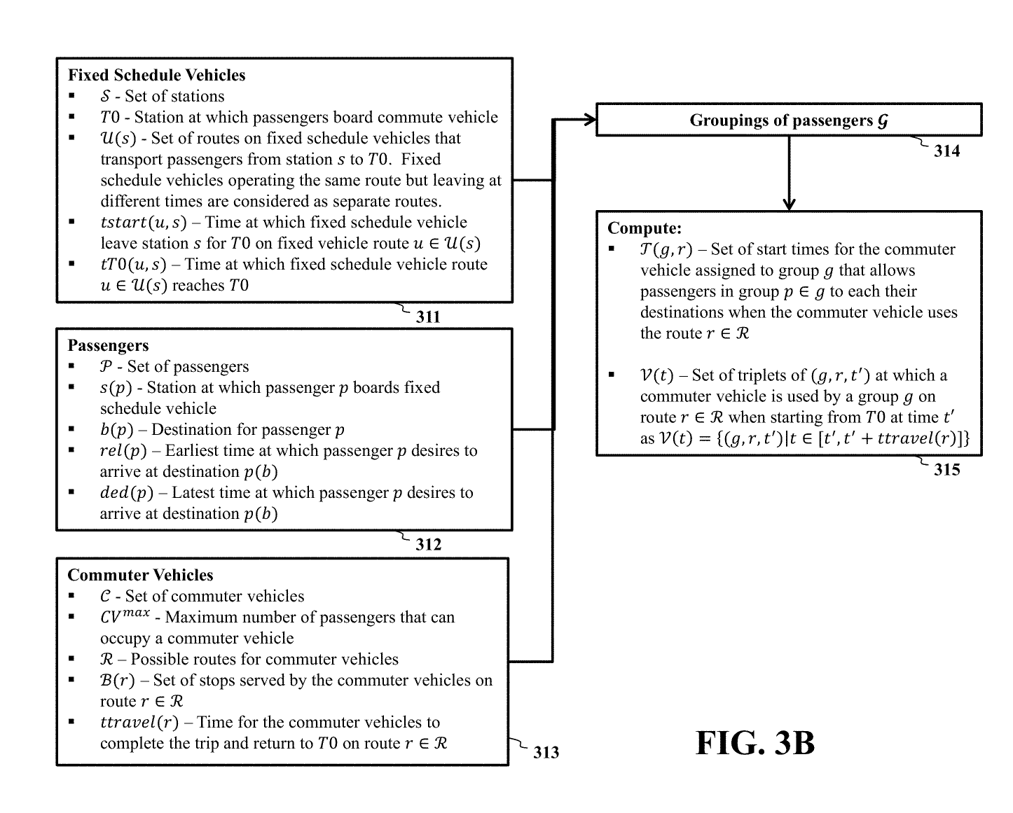

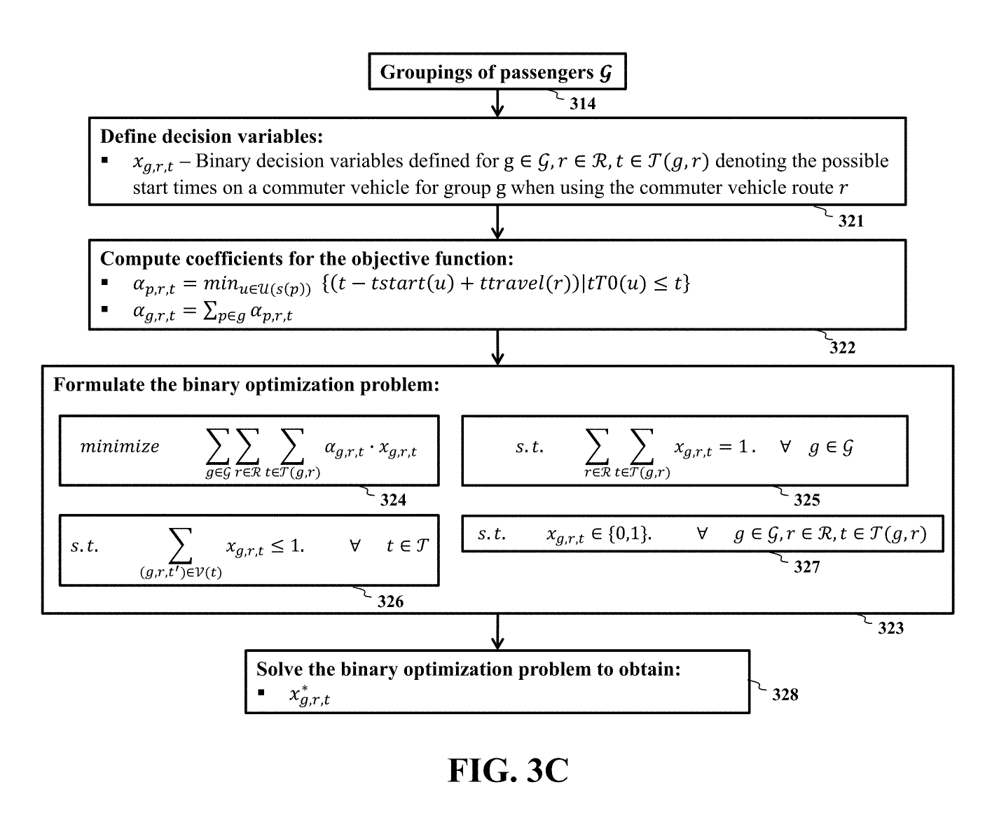

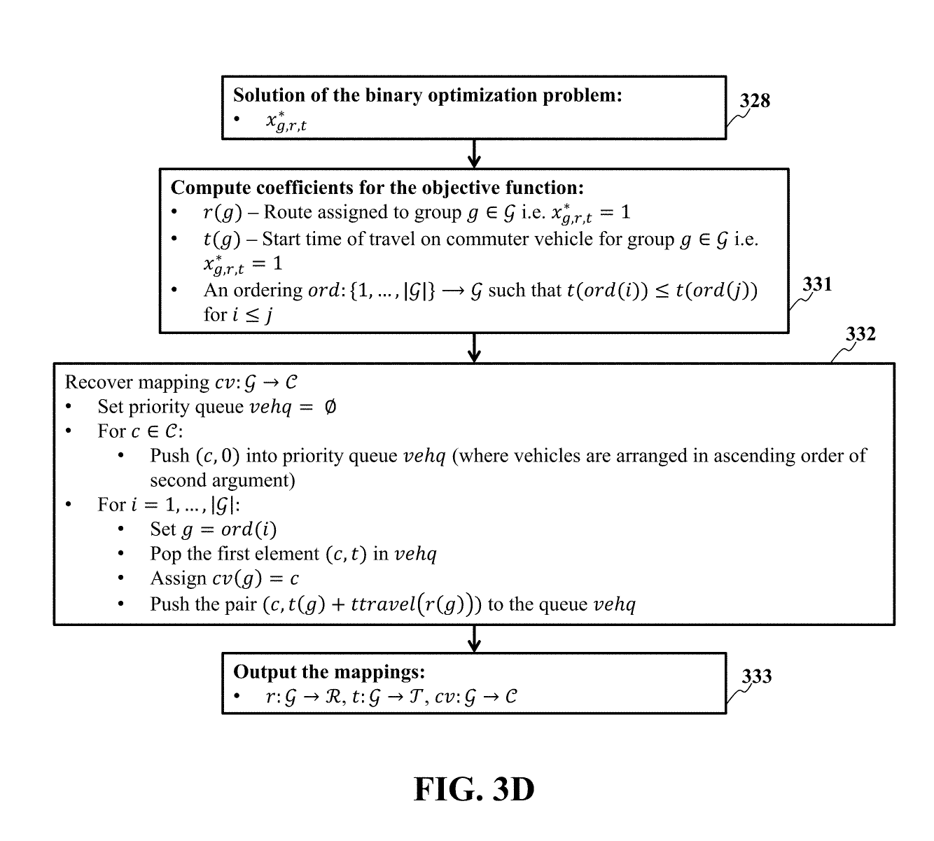

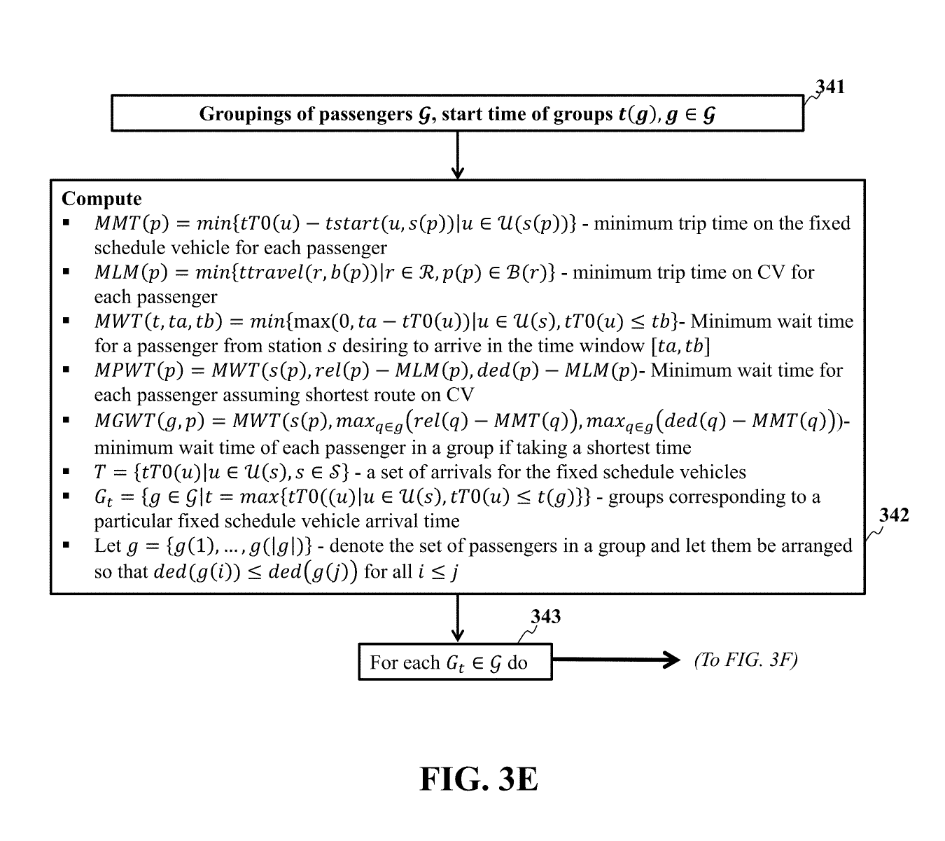

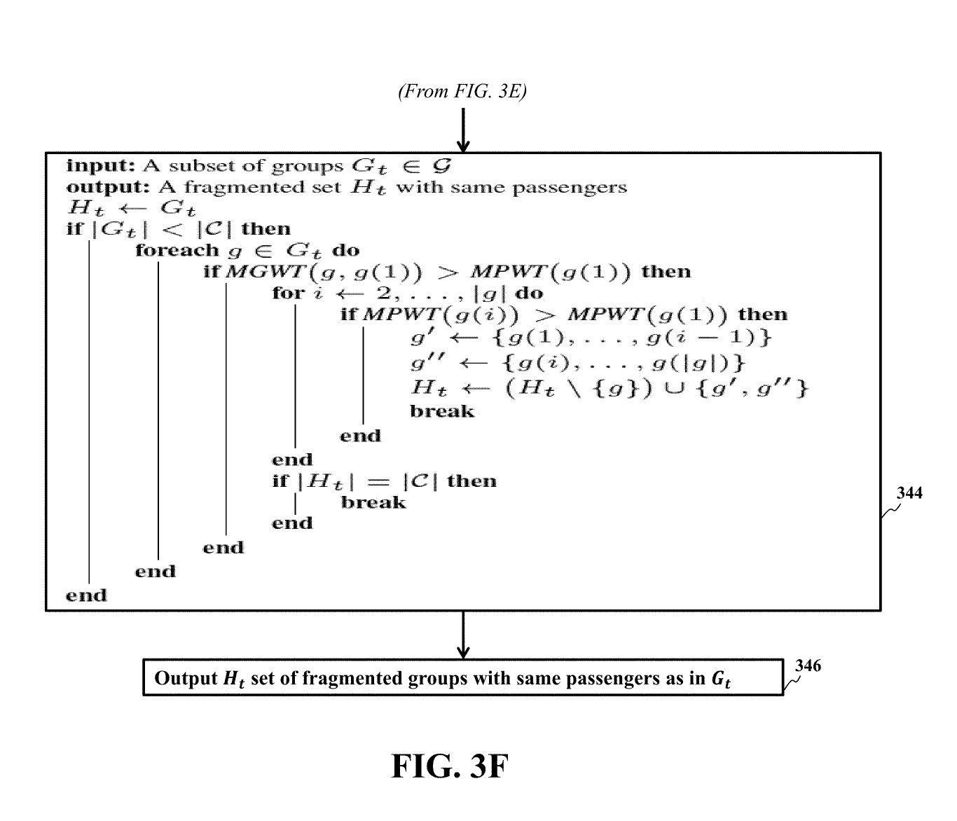

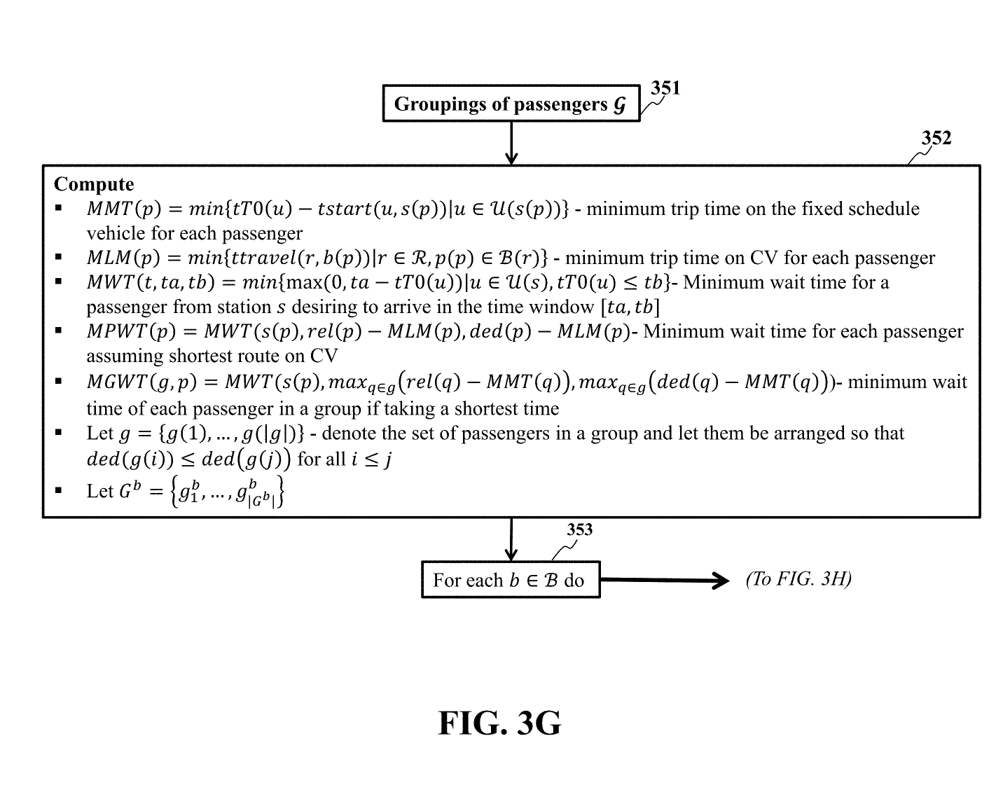

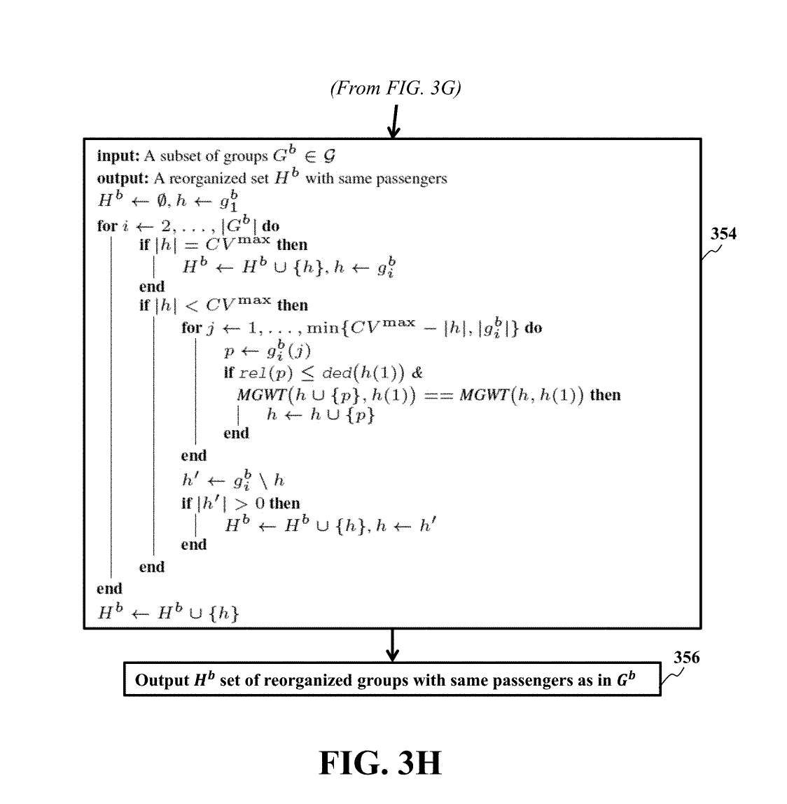

FIG. 3A is a block diagram of illustrating the flowchart of a method of FIG. 1A where the method continues to search for other passenger groupings, according to embodiments of the present disclosure.

The method consists of a master problem 300 and a subproblem 310. The master problem searches over the space of passenger groupings while the subproblem determines a scheduling of the passengers. Given a grouping of passengers from the master problem the method formulates the binary optimization problem 320 to determine if there exists a feasible assignment of commuter vehicles to groups, start times and routes for the groups so that the passengers reach their destinations in their desired time-windows. If the assignment is feasible 330 then the method proceeds to find another grouping of passenger and repeats the process. The obtained schedule for the chosen grouping is stored in a database 350 of solutions. If the grouping is not feasible the method relaxes the time-window of arrival for the passengers 340 and checks if a feasible solution can be obtained in 320. The relaxation of time windows is obtained by decreasing the lower limit of the time window and increasing the upper limit of the time window. This results in time windows for the groups that includes the previous time window for which the problem was infeasible. Hence, the action of relaxing time windows is guaranteed to result in a feasible solution, albeit at the possible violation of time windows for some passengers. The relaxation of time windows proceeds until a schedule can be obtained.

FIG. 3B is a block diagram illustrating the method of FIG. 1A, describing the inputs to the binary optimization algorithm for determining the optmal scheduling for a given set of groupings, according to embodiments of the present disclosure.

The inputs include for the fixed schedule vehicles 311: the set of stations that are served by the fixed schedule vehicles; the station at which the passengers board the commuter vehicles after alighting from the fixed schedule vehicle. Given the schedules for the fixed schedule vehicles, the method can readily compute the set of all routes on the fixed schedule vehicles that allows passengers to reach the station for boarding the commuter vehicles from the originating station. For each such route on the fixed schedule vehicle, the start time of the journet on the route and the time to reach the station where the passengers board the commuter vehicles can also be computed. The input for the passengers 312 include: the set of all passengers; the originating station; the destination building; and the earliest and latest deadline that the passenger desires to reach the destination. The input for commuter vehicles 313 include: the set of commuter vehicles that are available; the capacity of the commuter vehicles; the set of possible routes for the commuter vehicles; the set of stops and the sequence in which they are visited on each route of the commuter vehicle; and the trip time for the vehicle to complete the route and return the station from where passengers board the commuter vehicles. Given the set of groupings of passengers 314 and the inputs on vehicles and passengers, the set of start times on possible route for each group can be computed for the commuter vehicles 315 and the set of triplets at which a commuter vehicles is used by a group on route when starting from the stations where the commuter vehicles leave with passengers from fixed schedule vehicles.

FIG. 3C is a block diagram illustrating the method of FIG. 1A, describing the formulation of the binary optimization problem for determining the optimal scheduling for a given set of groupings, according to embodiments of the present disclosure.

The decision variables in the problem 321 are the binary variables determining if a particular route is assigned to a group to start at a particular time. From the groupings of passengers and information on the fixed schedule and commuter vehicles, the coefficients in the objective function 322 are computed. The objective function and the constraints in the problem 323 are used to formulate the binary optimization problem. The objective function 324 is the total travel time for all passengers across multile modes of transportation. The constraints 325 model that every group has unique route and start time. The constraints 326 model that each vehicle is not used by more more than group at each time instant. The constraints 327 restrict the variables to only take binary values. The optimal solution of the binary optimization problem is obtain 328 from solving the binary optimization problem. By non-limiting example, steps for solving a binary optimization problem based on the branch-and-bound strategy can be described as:
1) The step including the requirement that variables can only take values 0 or 1 is relaxed to requiring that the variables be continuous and between 0 and 1. This can be the so called the linear relaxation of the problem;
2) The step that linear relaxation of the problem can be solved. The optimal objective value of the linear relaxation can be termed the lower bound;
3) The step that if the solution has all the variables taking values that are either 0 or 1, then the binary optimization problem has been solved;
4) Otherwise, the step that two new sub-problems are created where in one of the sub-problems a single variable is fixed to take the value 0 and in the other sub-problem fixed to take a value of 1. The bounds on the remaining variables in the sub-problems are retained from the preceding problem from which the two problems were created. This fixing of the variables is termed as branching on a variable. The variable that is branched on is typically one that has a value between 0 and 1 at the solution of the relaxation;
5) The step that two new sub-problems are each called nodes and can be stored as part of a search tree;
6) The step including the branch and bound algorithm proceeds by picking a node from the search tree, and then repeating the steps of;
7) The step that can include a node (sub-problem) is not active when any of the following occurs: (A) The node is being branched on; (B) The solution is integral; (C) The subproblem is infeasible; or (D) The node can be discarded by a bounding argument, i.e. the node does not have any optimal solution that can improve upon the current best solution.

8) The step includes the branch and bound algorithm proceeds by choosing an active node and then branches on a fractional variable. The algorithm proceeds until there are no active sub-problems.

FIG. 3D is a block diagram illustrating the method of FIG. 1A, describing the algorithm for recovering the assignments of commuter vehicles to groups from the solution of the binary optimization problem, according to embodiments of the present disclosure.

Given the solution from the binary optimization problem, the algorithm assigns for each group 331 the route and start time time on the commuter vehicle. The vehicle index is obtained using the steps described 332 and finally, the output mappings are obtained 333.

FIG. 3E and FIG. 3F are block diagrams illustrating the method of FIG. 1A, describing the algorithm for breaking a given groupings of passengers into more groupings of passengers in an effort to reduce the waiting times that a passengers causes other passengers in the group, according to the embodiments of the present disclosure.

Referring to FIGS. 3E and 3F, given the set of groupings and the start times for all the groups 341, the algorithm computes a number of quantities 342 that are related to the minimum wait times for the passengers and the groups that are incurred on the fixed schedule vehicles and the CVs. Based on these computed quantities the algorithm picks sets of groups that are served by a particular fixed schedule vehicle 343 and breaks the group into smaller groups 344 so that the delays that passengers incur are reduced. Finally, the new set of groups 346 are output by the algorithm.

FIG. 3G and FIG. 3H are block diagrams illustrating the method of FIG. 1A, describing the algorithm for reducing the number of groups introduced by the algorithm in FIGS. 3E and 3F, according to the embodiments of the present disclosure.

Referring to FIGS. 3G and 3H, given the set of groupings 351 that are obtained from the application of the algorithm in FIGS. 3E and 3F, the algorithm in FIG. 3G and FIG. 3H compute a number of quantities 352 that are related to the minimum wait times for the passengers and the groups that are incurred on the fixed schedule vehicles and the CVs. In one embodiment of the algorithm the passengers are only grouped by destinations, in that only passengers to the same destination share a CV. Based on these computed quantities the algorithm picks sets of groups that are traveling to the same destination and attempts to merge groups 354 so that the number of groups are reduced without increasing significant delays for passengers. Finally, the new set of groups 356 are output by the algorithm.

In one embodiment of the present disclosure, the algorithms in FIG. 3E to FIG. 3H are executed sequentially after a feasible solution is found in algorithm of FIG. 3A to yield another set of groups 360.

According to aspects of the present disclosure, can include the corresponding routes from the set of predetermined routes that transport all passengers in the group, include locations from their initial locations to an intermediate location on a fixed schedule vehicle, from an intermediate location to their target location on the commuter vehicle, or from their initial locations to an intermediate location on the commuter vehicle, from an intermediate location to their target location on the fixed schedule vehicle, within the requested time windows. Wherein the assigned travel itinerary includes an identification of the commuter vehicle assigned to the identified group of the passenger, and a service time from the schedule assigned to the commuter vehicle to transport the passenger. Such that the transmitter can further transmit to the commuter vehicle, a set of schedules assigned to the commuter vehicle, and other information.

According to aspects of the present disclosure, can include the fixed schedule vehicles have fixed schedules and unconstrained passenger capacities to transport the set of passengers to, or from, the intermediate location, and wherein the commuter vehicles have unconstrained schedules and the maximum passenger capacity to transport the passengers to, or from, the intermediate location via at least one route selected from the set of predetermined routes. Further, the fixed schedule vehicles transport the passengers from their initial locations to the intermediate location, and wherein the commuter vehicles transport the passengers from the intermediate location to their target locations, and wherein the service time from the schedule is a starting time from the schedule assigned to the commuter vehicle to leave the intermediate location. Or, the fixed schedule vehicles transport the passengers from the intermediate location to their target locations, and wherein the commuter vehicles transport the passengers from their initial locations to the intermediate location, and wherein the service time from the schedule is a starting time assigned to the commuter vehicle to leave the initial location of the passenger.

According to aspects of the present disclosure, it is possible that the fixed schedule vehicles can include one or combinations of a train, a bus, a boat, and a plane, and wherein the commuter vehicles include one or combinations of an autonomous vehicle, a semi-autonomous vehicle, and a vehicle operated by a driver. Further still, that the groups of the passengers can be identified by ordering according increasing order of deadlines of passengers and based on that order determining if a passenger can be added to an existing groups of passengers without violating the capacity restriction on commuter vehicle and the existence of a route on commuter vehicle that allows the time windows to be satisfies for all passengers in the group and if no such group exists creating a new group with the passenger as the only member.

According to aspects of the present disclosure, the identifying of the groups of the passengers can be without considering schedules of the schedule vehicles and without considering the total travel time of the set of passengers. Further, the assigning of the identified group to optimize the total travel time of the passengers can be based on using a binary optimization.

According to aspects of the present disclosure, further the processor increases at least some time windows for at least some passengers by decreasing the lower limit on the time window and increasing the upper limit on the time window and determined the optimal assignment of commuter vehicles and services times, and iterating the steps of increasing the time window and solving if infeasibility still exists and repeating until a feasible solution is obtained.

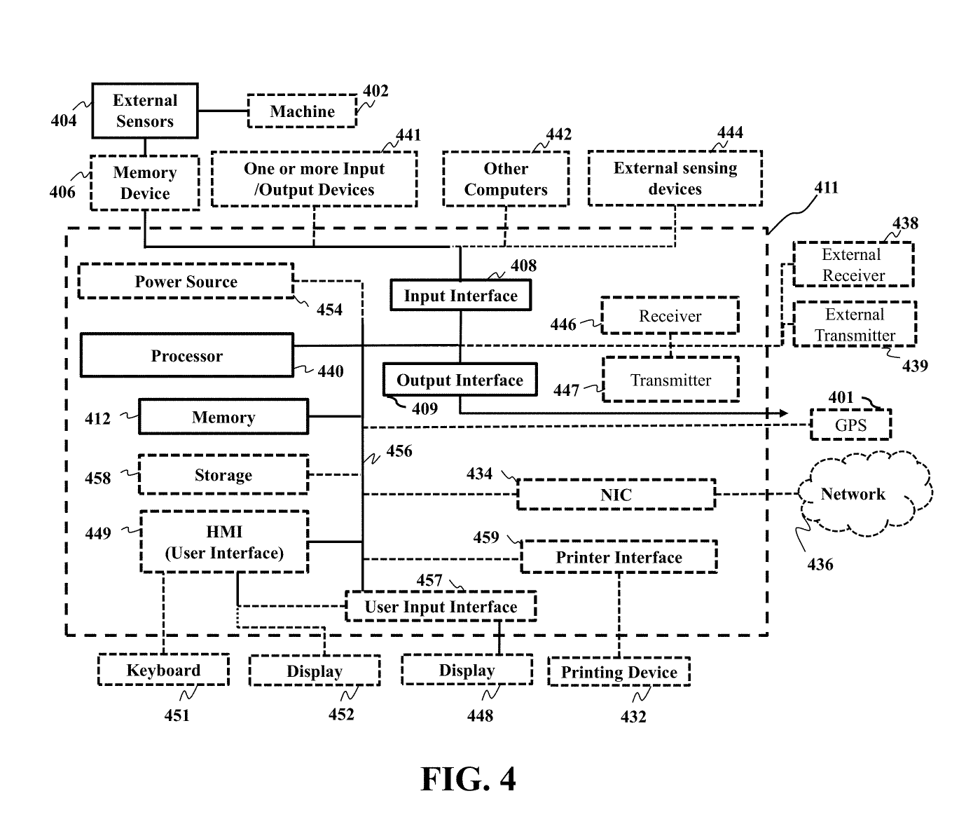

FIG. 4 is a block diagram of illustrating the method of FIG. 1A, that can be implemented using an alternate computer or processor, according to embodiments of the present disclosure. The computer 411 includes a processor 440, computer readable memory 412, storage 458 and user interface 449 with display 452 and keyboard 451, which are connected through bus 456. For example, the user interface 449 in communication with the processor 440 and the computer readable memory 412, acquires and stores the data (i.e., data relating to controlling movement of the elevator cars or elevator systems, elevator system operational historical data, elevator system optimization related data related to assigning halls calls to elevator cars of a similar elevator system), in the computer readable memory 412 upon receiving an input from a surface, keyboard surface, of the user interface 457 by a user.

Contemplated is that the memory 412 can store instructions that are executable by the processor, historical data, and any data to that can be utilized by the methods and systems of the present disclosure. The processor 440 can be a single core processor, a multi-core processor, a computing cluster, or any number of other configurations. The processor 440 can be connected through a bus 456 to one or more input and output devices. The memory 412 can include random access memory (RAM), read only memory (ROM), flash memory, or any other suitable memory systems.

Still referring to FIG. 4, a storage device 458 can be adapted to store supplementary data and/or software modules used by the processor. For example, the storage device 458 can store historical data and other related data such as manuals for the devices of the elevator system or similar types of elevator systems, wherein the devices can include sensing devices capable of obtaining data as mentioned above regarding the present disclosure. Additionally, or alternatively, the storage device 458 can store historical data similar to the data. The storage device 458 can include a hard drive, an optical drive, a thumb-drive, an array of drives, or any combinations thereof.

The system can be linked through the bus 456 optionally to a display interface (not shown) adapted to connect the system to a display device (not shown), wherein the display device can include a computer monitor, camera, television, projector, or mobile device, among others.

The computer 411 can include a power source 454, depending upon the application the power source 454 may be optionally located outside of the computer 411. Linked through bus 456 can be a user input interface 457 adapted to connect to a display device 448, wherein the display device 448 can include a computer monitor, camera, television, projector, or mobile device, among others. A printer interface 459 can also be connected through bus 456 and adapted to connect to a printing device 432, wherein the printing device 432 can include a liquid inkjet printer, solid ink printer, large-scale commercial printer, thermal printer, UV printer, or dye-sublimation printer, among others. A network interface controller (NIC) 434 is adapted to connect through the bus 456 to a network 436, wherein measuring data or other data, among other things, can be rendered on a third party display device, third party imaging device, and/or third party printing device outside of the computer 411.

Still referring to FIG. 4, the data or other data, among other things, can be transmitted over a communication channel of the network 436, and/or stored within the storage system 458 for storage and/or further processing. Further, the measuring data or other data may be received wirelessly or hard wired from a receiver 446 (or external receiver 438) or transmitted via a transmitter 447 (or external transmitter 439) wirelessly or hard wired, the receiver 446 and transmitter 447 are both connected through the bus 3456. The computer 411 may be connected via an input interface 408 to external sensing devices 444 and external input/output devices 441. The computer 411 may be connected to other external computers 442. An output interface 409 may be used to output the processed data from the processor 440.

The above-described embodiments of the present disclosure can be implemented in any of numerous ways. For example, the embodiments may be implemented using hardware, software or a combination thereof. Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A system for controlling vehicles in a multi-modal transportation network having fixed schedule vehicles and commuter vehicles, the system comprising:
a receiver to receive a request for transportation from passengers in a set of passengers, wherein each request from the passenger includes an initial location, a target location, and a time window for arriving at a target location or leaving an initial location;
a processor in communication with the receiver, is configure to
jointly optimize travel times of the set of passengers to reach their corresponding target locations, wherein the joint optimization is based on identifying groups of passengers from the set of passengers to obtain a set of groups of passengers, such that each group is associated with a set of schedules including combinations of starting times of the fixed schedule vehicles and the commuter vehicles, and corresponding routes from a set of predetermined routes that transport all passengers in the group, within the requested time windows, wherein each group includes a number of passengers not exceeding a maximum passenger capacity of commuter vehicles transporting passengers;
assign an identified group to a commuter vehicle leaving or reaching the intermediate location, wherein each passenger is assigned to a fixed schedule vehicle reaching the intermediate location prior to the departure of the commuter vehicle, or leaving the intermediate location after the arrival of the commuter vehicle, according to a schedule from the set of schedules associated with the identified group, by optimizing jointly a function of a total travel time of the set of passengers, from the initial location to the target location subject to constraints on transporting each group of passengers together, according to at least one schedule of the set of schedules associated with each group, so as to obtain an assigned travel itinerary for each passenger; and
a transmitter in communication with the processor, to transmit to each passenger their assigned travel itinerary in the multi-modal transportation network.

2. The system according to claim 1, wherein the corresponding routes from the set of predetermined routes that transport all passengers in the group, include locations from their initial locations to an intermediate location on a fixed schedule vehicle, from an intermediate location to their target location on the commuter vehicle, or from their initial locations to an intermediate location on the commuter vehicle, from an intermediate location to their target location on the fixed schedule vehicle, within the requested time windows.

3. The system according to claim 1, wherein the assigned travel itinerary includes an identification of the commuter vehicle assigned to the identified group of the passenger, and a service time from the schedule assigned to the commuter vehicle to transport the passenger.

4. The system according to claim 1, wherein the transmitter further transmits to the commuter vehicle, a set of schedules assigned to the commuter vehicle.

5. The system of claim 1, wherein the fixed schedule vehicles have fixed schedules and unconstrained passenger capacities to transport the set of passengers to, or from, the intermediate location, and wherein the commuter vehicles have unconstrained schedules and the maximum passenger capacity to transport the passengers to, or from, the intermediate location via at least one route selected from the set of predetermined routes.

6. The system of claim 5, wherein the fixed schedule vehicles transport the passengers from their initial locations to the intermediate location, and wherein the commuter vehicles transport the passengers from the intermediate location to their target locations, and wherein the service time from the schedule is a starting time from the schedule assigned to the commuter vehicle to leave the intermediate location.

7. The system of claim 5, wherein the fixed schedule vehicles transport the passengers from the intermediate location to their target locations, and wherein the commuter vehicles transport the passengers from their initial locations to the intermediate location, and wherein the service time from the schedule is a starting time assigned to the commuter vehicle to leave the initial location of the passenger.

8. The system of claim 1, wherein the fixed schedule vehicles include one or combinations of a train, a bus, a boat, and a plane, and wherein the commuter vehicles include one or combinations of an autonomous vehicle, a semi-autonomous vehicle, and a vehicle operated by a driver.

9. The system of claim 1, wherein the groups of the passengers are identified by ordering according increasing order of deadlines of passengers and based on that order determining if a passenger can be added to an existing groups of passengers without violating the capacity restriction on commuter vehicle and the existence of a route on commuter vehicle that allows the time windows to be satisfies for all passengers in the group and if no such group exists creating a new group with the passenger as the only member.

10. The system of claim 1, wherein the identifying of the groups of the passengers is without considering schedules of the schedule vehicles and without considering the total travel time of the set of passengers.

11. The system of claim 1, wherein the assigning of the identified group to optimize the total travel time of the passengers is based on using a binary optimization.

12. The system of claim 1, wherein the processor increases at least some time windows for at least some passengers by decreasing the lower limit on the time window and increasing the upper limit on the time window and determined the optimal assignment of commuter vehicles and services times, and iterating the steps of increasing the time window and solving if infeasibility still exists and repeating until a feasible solution is obtained.

13. A method for controlling vehicles in a multi-modal transportation network having fixed schedule vehicles and commuter vehicles, wherein the fixed schedule vehicles have fixed schedules and unconstrained passenger capacities to transport a set of passengers to, or from, an intermediate location, and wherein the commuter vehicles have unconstrained schedules and a maximum passenger capacity to transport the passengers to, or from, the intermediate location, via at least one route selected from a set of predetermined routes, the method comprising:
receiving via a receiver a request for transportation from passengers in the set of passengers, each request from a passenger includes an initial location, a target location, and a time window for arriving at the target location, or leaving the initial location, and storing the received request in a memory;
using a processor in communication with the receiver and the memory, that is configure to
jointly optimize travel times of the set of passengers to reach their corresponding target locations, wherein the joint optimization is based on identifying groups of passengers from the set of passengers to obtain a set of groups of passengers, such that each group is associated with a set of schedules including combinations of starting times of the fixed schedule vehicles and the commuter vehicles, and corresponding routes from a set of predetermined routes that transport all passengers in the group, within the requested time windows, wherein each group includes a number of passengers not exceeding the maximum passenger capacity of commuter vehicles transporting passengers;
assign an identified group to a commuter vehicle leaving or reaching the intermediate location, wherein each passenger is assigned to a fixed schedule vehicle reaching the intermediate location prior to the departure of the commuter vehicle, or leaving the intermediate location after the arrival of the commuter vehicle, according to a schedule from the set of schedules associated with the identified group, by optimizing jointly a function of a total travel time of the set of passengers, from the initial location to the target location subject to constraints on transporting each group of passengers together, according to at least one schedule of the set of schedules associated with each group, so as to obtain an assigned travel itinerary for each passenger; and
a transmitter in communication with the processor, to transmit to each passenger their assigned travel itinerary in the multi-modal transportation network.

14. The method of claim 13, wherein the corresponding routes from the set of predetermined routes that transport all passengers in the group, include locations from their initial locations to an intermediate location on a fixed schedule vehicle, from an intermediate location to their target location on the commuter vehicle, or from their initial locations to an intermediate location on the commuter vehicle, from an intermediate location to their target location on the fixed schedule vehicle, within the requested time windows.

15. The method of claim 14, wherein the assigning of the identified group to optimize the total travel time of the passengers is based on using a binary optimization.

16. The method of claim 15, wherein the binary optimization optimizing jointly a function of a total travel time of the set of passengers, from the initial location to the target location subject to constraints on transporting each group of passengers together, according to at least one schedule associated with each group.

17. The method of claim 13, wherein the assigning of the identified group to optimize the total travel time of the passengers is based on using a binary optimization.

18. A non-transitory computer readable storage medium embodied thereon a program executable by a computer for performing a method, the method for controlling vehicles in a multi-modal transportation network having fixed schedule vehicles and commuter vehicles, the method comprising:
receiving via a receiver a request for transportation from passengers in the set of passengers, each request from a passenger includes an initial location, a target location, and a time window for arriving at the target location, or leaving the initial location, and storing the received request in a memory;
using a processor in communication with the receiver and the memory, that is configure to
jointly optimize travel times of the set of passengers to reach their corresponding target locations, wherein the joint optimization is based on identifying groups of passengers from the set of passengers to obtain a set of groups of passengers, such that each group is associated with a set of schedules including combinations of starting times of the fixed schedule vehicles and the commuter vehicles, and corresponding routes from a set of predetermined routes that transport all passengers in the group, within the requested time windows, wherein each group includes a number of passengers not exceeding the maximum passenger capacity of commuter vehicles transporting passengers;
assign an identified group to a commuter vehicle leaving or reaching the intermediate location, wherein each passenger is assigned to a fixed schedule vehicle reaching the intermediate location prior to the departure of the commuter vehicle, or leaving the intermediate location after the arrival of the commuter vehicle, according to a schedule from the set of schedules associated with the identified group, by optimizing jointly a function of a total travel time of the set of passengers, from the initial location to the target location subject to constraints on transporting each group of passengers together, according to at least one schedule of the set of schedules associated with each group, so as to obtain an assigned travel itinerary for each passenger; and
a transmitter in communication with the processor, to transmit to each passenger their assigned travel itinerary in the multi-modal transportation network.

19. The method of claim 18, wherein the fixed schedule vehicles have fixed schedules and unconstrained passenger capacities to transport the set of passengers to, or from, the intermediate location, and wherein the commuter vehicles have unconstrained schedules and the maximum passenger capacity to transport the passengers to, or from, the intermediate location via at least one route selected from the set of predetermined routes, and wherein the fixed schedule vehicles transport the passengers from their initial locations to the intermediate location, and wherein the commuter vehicles transport the passengers from the intermediate location to their target locations, and wherein the service time from the schedule is a starting time from the schedule assigned to the commuter vehicle to leave the intermediate location.

20. The method of claim 18, wherein the corresponding routes from the set of predetermined routes that transport all passengers in the group, include locations from their initial locations to an intermediate location on a fixed schedule vehicle, from an intermediate location to their target location on the commuter vehicle, or from their initial locations to an intermediate location on the commuter vehicle, from an intermediate location to their target location on the fixed schedule vehicle, within the requested time windows.
